(19) United States
(12) Patent Application Publication
(10) Pub. No.: US 2008/0046562 A1
(43) Pub. Date: Feb. 21, 2008

(54) VISUAL WEB PAGE ANALYTICS

(75) Inventor: John BUTLER, Eugene, OR (US)

Correspondence Address: WILMERHALE/BOSTON, 60 STATE STREET, BOSTON, MA, 02109, US

(73) Assignee: CRAZY EGG, INC., La Mirada, CA (US)

(21) Appl. No.: 11/841,397

(22) Filed: Aug. 20, 2007

Related U.S. Application Data
(60) Provisional application No. 60/838,978, filed on Aug. 21, 2006.

(51) Int. Cl. G06F 15/173

(52) U.S. Cl. 709/224

(57) ABSTRACT

A method and system for tracking user utilization of a web page. The invention can use a tracking script, which can be a client-based Javascript code in some embodiments. The tracking script can be executed in a visitor's web browser when the customer's web page is loaded on the visitors' computer. The tracking script can be unique to each customer because it can be determined by the elements on the customer's web page and can be generated via a dynamic web server process. In at least some embodiments, when the customer's web page loads on the visitor's computer, the visitor's browser requests the tracking script from a server. The server can then transmit the tracking script to the visitor's browser and the tracking script can register itself and “passively” listens to various browser events.

### CROSS REFERENCE TO RELATED APPLICATIONS

This application claims benefit of the following patent application: U.S. Provisional Patent Application Ser. No. 60/838,978, filed on Aug. 21, 2006.

### BACKGROUND OF THE INVENTION

Site statistic software has been around since the beginning of the commercial World Wide Web. However, there has been little innovation in the field. There are several commercially-available software packages, but these packages fail to meet consumers' needs. There are three major flaws in current software offerings: (1) they entail complex, time-consuming set-up processes; (2) they present an incomplete picture of user activity on the consumer's web site; and (3) the limited information these programs provide is presented to consumers in confusing and often useless forms.

Analytics software is often difficult and time-consuming to install and configure. Some web analytics software, such as Mint®, must be installed on the customer's web server. Server-based analytical tools must interface with other software packages, which can make the installation process complex and laborious. In fact, the knowledge required to install server-based software far exceeds the technical ability of the average website owner.

Moreover, the majority of websites are hosted on shared hosting plans that restrict the kinds software the customer can install. Thus, many customers are stuck with the statistical software their hosting provider has selected. Other tracking software is “client-based”, which means that the tracking code is executed on the client's system (typically within a site user's web browser, such as Internet Explorer® or Firefox®). Client-based software does not require the installation of software on the consumer's web server. Instead, the software company typically hosts the server-side of the software. However, client-based tracking software can still require significant set-up and configuration. For example, Google Analytics® is incapable of tracking links on a consumer's web page that connect to another website unless the consumer manually modifies each such link. This is an extremely time-consuming process for consumers whose websites contain many out-bound links. Consumers prefer software that is easy to install, can run on any hosted web service plan (including shared hosting plans), and requires little to no configuration.

Another drawback of existing analytics software is its failure to present a complete picture of user activity on a customer's website. Most currently-available software packages only track the URL of the customer's page and basic visitor information, such as browser type, screen resolution, operating system, IP address and referring URL information. If a customer's web page contains a set of navigational links at the top of the page and an identical set of navigational links at the bottom of the web page (a very common web page configuration), most currently-available analytics software cannot tell the customer if a site visitor clicked the links at the top of the page or at the bottom of the page. Other analytics packages tell the customer only the visitor's ultimate destination within a website but not the series of links the user selected to reach that ultimate destination. In addition, URL-based tracking software is incapable of tracking non-URL elements on a web page, including web forms, buttons, images, and plug-ins (e.g., Macromedia Flash components). Finally, most currently-available analytics software packages cannot accurately track most online advertising placed on web pages. The inability to easily and accurately track advertising clicks is a major flaw in most available software packages. All of these types of “missing” information could be extremely valuable to, inter alia, site owners who are seeking to maximize their advertising revenues, user interface architects who build web applications, and web page designers looking to track the effectiveness of their designs.

Moreover, tracking URLs alone is an outdated method of analysis. However, many currently-available tracking packages fall apart on highly dynamic web pages (such as blogs, news sites, and dynamic stores).

Another area where current analytics software falls short is in information presentation. Most software packages provide an overwhelming amount of information organized into a confusing array of numbers, tables, and charts. Consumers complain that they are unable to interpret and utilize the information provided by existing analytics packages.

Furthermore, no currently-available analytics software package allows consumers to easily compare the effectiveness of multiple site designs and layouts. Thus, there is a need in the field for innovative, consumer-friendly site statistic software programs that accurately capture user activity.

### SUMMARY OF THE INVENTION

According to one aspect, the invention is a method or system for tracking user utilization of a web page. In one such embodiment, the invention can use a tracking script, which can be a client-based Javascript code in some embodiments. The tracking script can be executed in a visitor's web browser when the customer's web page is loaded on the visitors' computer. The tracking script can be unique to each customer because it can be determined by the elements on the customer's web page and can be generated via a dynamic web server process. In at least some embodiments, when the customer's web page loads on the visitor's computer, the visitor's browser requests the tracking script from a server. The server can then transmit the tracking script to the visitor's browser and the tracking script can register itself and “passively” listen to various browser events. According to one feature in some embodiments, the tracking script is “passive” in that it monitors browser events and the visitor is unable to view the tracking script's activity and is unaffected while the tracking script runs.

In some embodiments, the present invention offers advanced features for more sophisticated users. The present invention can use client-based tracking software that requires no configuration. Customers need only enter the URL of their web page and copy and paste a single line of Javascript in order to use the present invention. Then, the invention automatically configures and updates itself. In some embodiments, the tracking script is able to track all of the information described above in the background, as well as a wealth of other information about visitors and their actions (e.g., the visitor's estimated geographic location and how long a visitor stays on a page before clicking on a link or other image).

In some embodiments, the invention uses sophisticated techniques to accurately track content and user navigation on dynamic pages. The value of this capability is becoming increasingly evident in the context of emerging web technologies. For example, a major new web technology is AJAX® (Asynchronous Javascript And XML). In AJAX, a web developer can write code that updates part of a web page without requiring the whole page to be reloaded. For example, consider a web page that displays the current weather at the top of the page. Using AJAX, the rest of the web page may remain static while the weather updates in real time every few minutes. Many web developers have found more sophisticated uses for AJAX, such as simulating complete Operating Systems that mimic the functionality of a desktop operating system with adjustable content boxes (windows). AJAX is becoming extremely popular, and most new web applications make heavy use of AJAX. However, URL-based analytics programs are unable to track AJAX events, rendering them increasingly obsolete as AJAX gains popularity. The present invention is capable of tracking AJAX events, thereby meeting current customer needs.

In some embodiments, the present invention addresses some problems in the prior art by choosing quality over quantity. The invention can display the collected information in a highly visual and easily digestible format. For example, in some embodiments, the invention includes a simple site overlay that displays the consumer's web page with superimposed statistics and a heatmap that quickly and clearly shows consumers which parts of their web page receive the most activity. The invention can also offer simple tools that segregate user data by various factors (e.g., time of day, date, or geographic location).

In some embodiments, the invention offers automatic A/B site testing, i.e., customers are able to create multiple layouts of the same web page and the invention can automatically and randomly partition site users to the various layouts. In addition, the invention can allow customers to pull up these different layouts, and the statistics gathered from them, side-by-side for easy comparison. Finally, the invention can enable customers to archive their various web page layouts, along with all of the user information collected for each page. Thus, customers can archive old reports, then completely change their web site while retaining old reports that accurately depict prior versions of the website.

In some embodiments, the present invention also offers unique features that advanced consumers have been requesting for a long time. For example, in some embodiments, the invention includes a full web application programming interface (“API”) that allows advanced customers to access their data in a variety of ways (including writing their own software to access their data on the server), “widgets” (small desktop applications) that show current site information, and a really simple syndication (“RSS”) feed to provide site statistics on a regular basis.

In some embodiments, the invention can use pages, such as a specific web page (e.g., a customer's “Home Page” or “About Page”). A page session or page test can be a specific test on a given page. A single page may have multiple page sessions. Each session or test may end on a specific date or after a specific number of user visits. A page version can be a web page with a unique URL. A page session may have multiple page versions.

A snapshot can be a representation of a page version at a given moment in time. A snapshot can be the combination of visual appearance and element position data. In some embodiments, a snapshot provides customers with a complete visual archive of each web page they have ever tested, as described more fully herein. A page version may have multiple snapshots.

A visitor can be a unique individual who visits a web page that is being tracked with invention. A visitor can be considered unique only for the period of their session (i.e., until the user exits his/her browser). A snapshot may have multiple visitors. A visit can refer to each time that a visitor views (hits) a webpage. A visitor may have multiple visits. If a visitor may visit the same page multiple times within a single browsing session; each visit registers as the same visitor, but multiple visits.

An element can be any trackable element on a given web page, including, but not limited to, links, images, form fields, form buttons, and other objects that have been given an onclick, such as a mousedown, mouseup, or click, event. A snapshot may have multiple elements.

A click can refer to appropriate user action on an element. In some embodiments, a click occurs when a user selects the element with the mouse. In other embodiments, a click will require other user action. For example, a form field registers a click when the user focuses the text entry caret on the text field.

A browser as used herein can be any software application used to access a web page. Common examples of browsers include, but are not limited to, Internet Explorer®, Firefox®, and Safari®.

### BRIEF DESCRIPTION OF THE DRAWINGS

FIG. 1 shows, in flowchart form, the process by which the unique tracking script is generated according to some embodiments of the present invention.

FIG. 2 shows, in flowchart form, the process by which the tracking script transmits information to the tracking server according to some embodiments of the present invention.

FIG. 3 shows, in flowchart form, the process by which the tracking script source code is obfuscated according to some embodiments of the present invention.

FIG. 4 shows the HTML grid that the tracking script places over an iframe on a customer's web page according to some embodiments of the present invention.

FIG. 5 shows a refined HTML grid used to accurately pinpoint a user's location within an iframe according to some embodiments of the present invention.

### DETAILED DESCRIPTION

A. Tracking Script

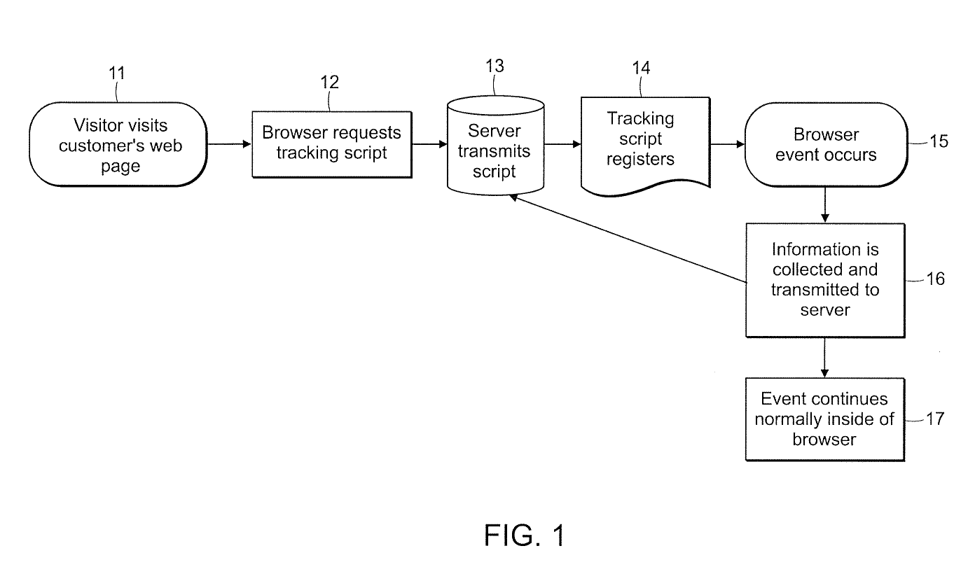

According to at least some embodiments of the present invention, the tracking script is client-based Javascript code that is executed in a visitor's web browser when the customer's web page is loaded on the visitors' computer. The tracking script is unique to each customer because it is determined by the elements on the customer's web page and is generated via a dynamic web server process, as shown in FIG. 1. In at least some embodiments, when the customer's web page loads on the visitor's computer (box 11), the visitor's browser requests the tracking script from the tracking server (box 12). The tracking server can be a separate server from that hosting the customer's web page. Thus, in one embodiment, an environment of the invention can include a visitor's PC that runs a web browser, a server that hosts the customer's web page, and a server that hosts the tracking script. In other embodiments, the same server can host the customer's web page and the tracking server.

The tracking server transmits the tracking script to the visitor's browser (box 13), and the tracking script registers itself and “passively” listens to various browser events (box 14). In FIG. 1, box 13 represents an act of the tracking server transmitting the tracking script to the visitor's browser. Box 13 can also be viewed as the tracking server itself. Box 14 represents the tracking script registering itself and passively listening to browser events, although box 14 can also be viewed as representing the tracking script itself. The tracking script is said to “passively” monitor browser events because the visitor is unable to view the tracker script's activity and is unaffected while the tracking script runs. For example, the tracking script may monitor browser events including, but not limited to, mouse movements, mouse clicks, and page exits. When one of the monitored browser events occurs (box 15), the tracking script takes a predetermined, preprogrammed action. For example, if the user clicks on a trackable element, such as a hyperlink, then the script may register a click. Each time a click is registered, the tracking script collects information about the clicked element. (An element in this case is any component, part, or region of a page and is not necessarily a “clickable” element.) In some embodiments, the tracking script will collect HTML (i.e., the markup language used to describe how elements are displayed on a web page), including the complete HTML for the element, the HTML just after the element, and the HTML before the element. In some embodiments, the tracking script collects the position of the mouse and/or how much time transpired between the loading of the page and the user click. Thus, the tracking script is able to track mouse movement and user behavior on a web site. All of the information collected by the tracking script can then immediately be sent to the tracking server (box 16), as described below, without interrupting the user's activities on the customer's web page, i.e., the information is transmitted in the background (box 17).

B. Data Transportation

As described above, the tracking script transmits information about browser events to the tracking server or servers in the background. Accordingly, visitors to a customer's web page will not perceive any interference with their browsing activities and, in fact, will be unable to tell that the web page is using the application of the present invention. In at least some embodiments, the present invention achieves this by sending information in the background and by failing silently. As used herein, “failing” means that the tracking servers malfunction or stop operating. If the tracking server fails, customers' web pages continue to be accessible and operate normally. The only consequence of a tracking server failure is the inability to track user activity on affected web pages.

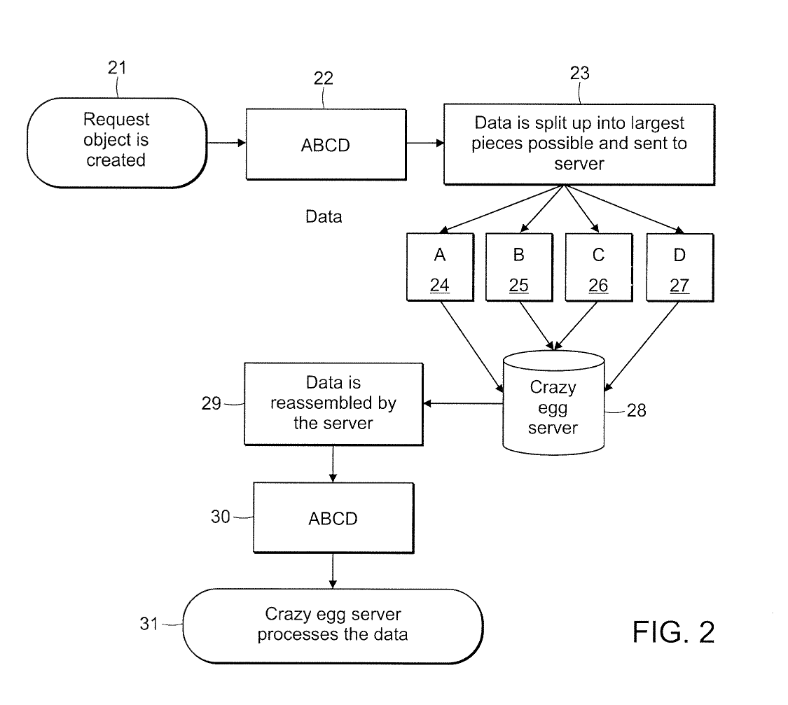

The process by which the invention transmits information to the tracking server in at least some embodiments of the present invention is depicted in FIG. 2. According to some embodiments, when the tracking script acquires information about a browser event, it creates a new “Request Object” (box 21). In at least some embodiments, the Request Object is a command that begins packaging the information to be sent from the customer's website to the tracking servers. The Request Object packages the information and prepares it for transmission using HTTP (Hypertext Transfer Protocol) and the GET (i.e., the most common type of HTTP request, which requests a representation of the specific resource) method. Presently, GET is only the method for transmitting data between two domains in the background. However, the transmission of information using the GET method is often problematic because each browser imposes various, non-standardized limits on the amount of data that can be transmitted using GET. To overcome this problem, in at least some embodiments, the Request Object breaks down (at box 23) the information 22 obtained from each visitor's browser into smaller pieces 24, 25, 26, 27, the total of which fall within the browser's limit. Each piece is then tagged with a unique index and sequence ID to facilitate processing of the information once it reaches the tracking server 28. For each piece of data, the request object dynamically creates an image object, makes the image “invisible,” and embeds it on the web page. The URL of the image is then set to a URL that contains the information for the data fragment. The visitor's browser then requests the URL from the tracking server 28, effectively transmitting the information fragment. The tracking server 28 then returns an “empty” image. By using image objects the tracking script can send requests in the background without tracking information inside the visitor's browser, e.g., by making a new entry in the browser's “History,” a technique used by many currently-available analytics programs.

The information fragments may arrive at the tracking server 28 in an order different from that in which they were created. Should this occur, the tracking server 28 reassembles the data fragments in order (boxes 29 and 30) and then processes the information (box 31).

C. Script Versioning

The tracking script uses a versioning process to manage changes that are made to the tracking script itself. According to at least some embodiments of the present invention, each time changes are made to the tracking script and/or new features are added to the invention, a new version of the tracking script is created. Despite this versioning, analytics reports produced under prior versions may remain accessible to the customer because each customer snapshot is permanently linked to the version of the tracking script in use at the time the snapshot is created. Thus, in at least some embodiments, the present invention permits significant re-versioning of the tracking script while allowing customer access to and use of reports produced under prior versions.

D. Script Obfuscation

Because the tracking script is displayed in the source code of the customer's web page, providers of client-based web analytics programs are constantly searching for effective ways to obfuscate the source code of the tracking script and, thereby, preserve both the secrecy of their proprietary information and their competitive advantages.

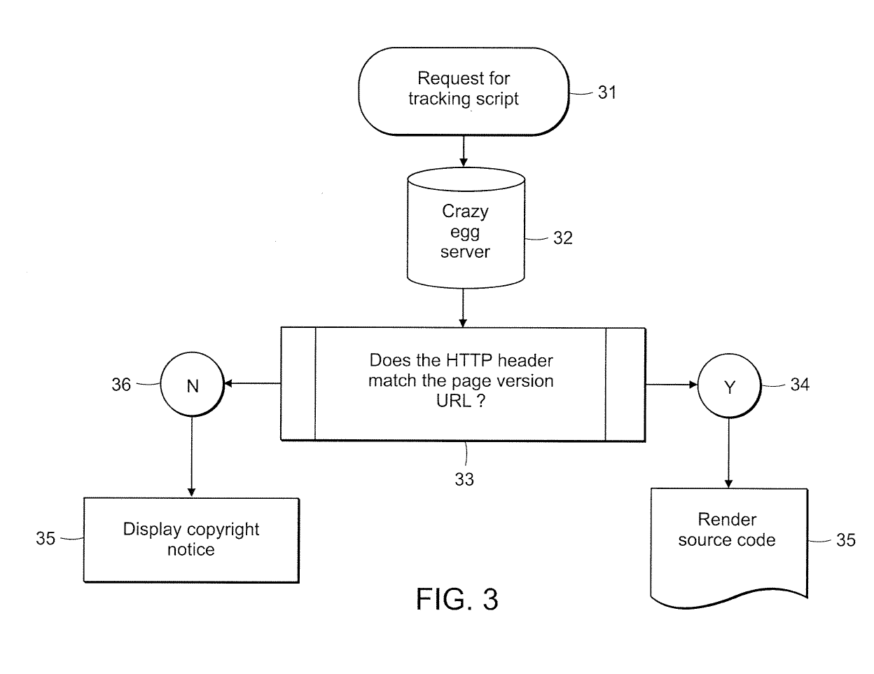

The present invention provides a novel and effective means of obfuscating the tracking script source code, one embodiment of which is shown in FIG. 3. In at least some embodiments, the tracking script is a web application process rather than a static file. Each time a user requests to view the client tracking script (box 31), the tracking server checks the HTTP header information of the requester (computer that is requesting the tracking script), for a “referrer,” i.e., the URL of the user requesting to view the client tracking script (box 32). The tracking server determines whether the referrer matches the URL of the page version (box 33). If the referrer does match the URL of the page version (box 34), the source code is rendered (box 35). This match validates that the user seeking the tracking script is the customer and not an unauthorized third party. In some embodiments, this matching process occurs automatically whenever a customer includes the tracking script on their web page. If no referrer is included in the HTTP header information or the provided referrer does not match the URL of the page being tracked (box 36), then a copyright notice is displayed instead (box 37).

In at least some embodiments, the referrer from any user trying to navigate directly to the tracking script will not match the URL of the page version and that user will also see the copyright notice.

E. Iframe Event Tracking

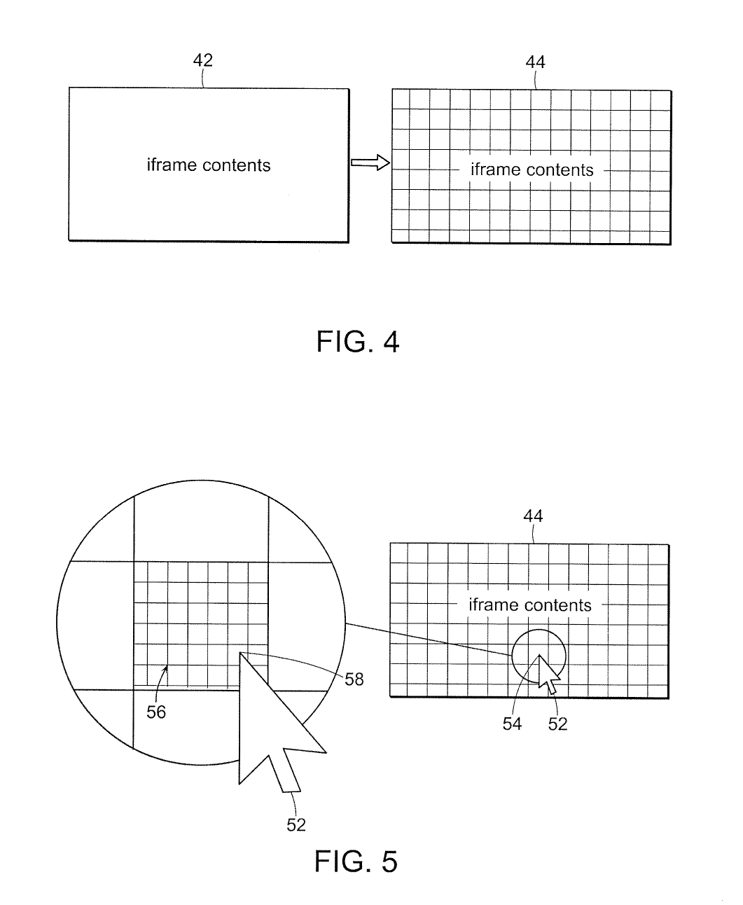

An “iframe” can be a section of the webpage that works like a separate and self-contained webpage. Tracking events within iframes is an important function for any website analytics program because, inter alia, advertising networks provide their ads in iframes. Thus, the information within the ad is stored on the advertiser's webpage. However, many web browsers (e.g., Internet Explorer®, FireFox®, Safari®) have built-in cross-domain security restrictions, which prevent source code from accessing information from sites other than that in use. Accordingly, these web browsers prohibit the source code from accessing information within an ad iframe. These same cross-domain restrictions may apply to the tracking script, blocking access to information within iframes and making it difficult to track such information located on a customer's webpage. Referring to FIG. 4, if a visitor moves his/her mouse onto an iframe 42, the tracking script is no longer able to monitor the mouse and assess visitor activity within the iframe. To overcome this problem, according to one embodiment of the invention, the tracking script places an invisible grid of HTML “squares” 44 over each iframe on a customer's webpage, as shown in FIG. 4.

Because the tracking script creates these squares, the tracking script “owns” them, and they are not subject to cross-domain restrictions. FIG. 5 shows a refined HTML grid 44 used to accurately pinpoint a user's location within an iframe according to some embodiments of the present invention. The left side of FIG. 5 is an enlarged view of one section of the right side of FIG. 5. According to at least some embodiments of the present invention, when a visitor moves his/her mouse 52 over one of the squares 54 created by the tracking script, the square hides itself and creates a new and more-refined grid 56 inside of its area, as shown on the left side of FIG. 5. This refining process continues until a certain degree of granularity is achieved, and the tracking script is able to accurately pinpoint the location of visitor events within the iframe.

In at least some embodiments and as shown on the left side of FIG. 5, the smallest square 58 directly under the mouse is completely invisible. This invisibility permits the mouse to “fall through” the grid cover and interact with the iframe below it. The mouse position is recorded and stored prior to making the final grid disappear. When the visitor moves his/her mouse, all hidden grid pieces replace themselves so that they may be re-used. Thus, the tracking script is able to monitor the mouse position at all times, including when a visitor moves their mouse over an iframe.

If a visitor leaves a web page while his/her mouse is inside of an iframe, the invention can register a “click” within the iframe.

F. Element Identification

In some embodiments, the present invention can track events on individual elements of a webpage and, therefore, needs a method to uniquely identify each element. Most web pages are changed frequently, so it is important that the present invention is able to process changes to a webpage while retaining the unique ID it generated for each element before the page changed. Unfortunately, HTML elements do not have a built-in ID mechanism that guarantees each element will have a unique and unchanging ID. To solve this shortcoming, the invention identifies an element using a combination of both the element's HTML and that surrounding the element, i.e., the HTML before and after the element. This is the same HTML information that the tracking script collects (see Section A, above). This HTML combination serves as a unique identifier for each element.

There are two distinct HTML identification phases: Input Identification and Output Identification. Input Identification occurs whenever a visitor clicks an element and that element's information is transmitted to the tracking server (see disclosure above). Output Identification occurs whenever a customer views a report for a web page (see disclosure below).

Each time a page is changed (e.g., when a website author posts a new item on his/her webpage), the HTML before and/or after an element may change. According to at least some embodiments, the present invention uses “fuzzy logic” rather than exact comparisons to accommodate changing code and continue to uniquely identify elements following a page change. To apply fuzzy logic, the invention determines a similarity score for two given pieces of HTML (see disclosure below). In some embodiments, the similarity score is a number that indicates the degree of similarity for two pieces of HTML. In these embodiments, the similarity score is based upon the number of changes (represented as deltas, Δs) required to make two pieces of HTML identical. The lower the similarity score, the more similar the two pieces of HTML. Two identical pieces of HTML would have a similarity score of zero.

Unfortunately, the complex nature of similarity score calculations can be server intensive and slow. In some embodiments, the present invention utilizes several optimizations intended to minimize the use of server resources. First, during the Input Identification process, the server may only compare newly-identified HTMLs to previously-identified elements. This limitation on the comparison process minimizes server resources, deferring more thorough analyses for the Output Identification process. Second, during the Input Identification process, the server may utilize strict comparison methods to prevent false positives; this is less server intensive because false positives can take up server resources if the strict comparison methods are not utilized. Third, during the Output Identification process, the server may retrieve the complete HTML for the customer's web page. This enables the server to consider all changes on the page. The server initiates loose, less intensive, and less specific comparison methods, but switches to stricter comparison methods when multiple possible matches in the HTML code are found. It is possible that two elements will be identified as different even if they are the same as a result of the stricter comparison processes applied during Input Identification. The Output Identification process is able to identify when this happens and merges the data automatically. If either the Input Identification or Output Identification process determines that the HTML of the element or the surrounding HTML has changed (e.g., due to new data received from the tracking script), the element's record may be updated to the most current HTML automatically.

G. HTML Normalization

In at least some embodiments of the present invention, the tracking script uses functionality built into the visitor's browser to collect an element's HTML as well as the HTML surrounding it (custom code may be used to determine what constitutes valuable HTML before or HTML after). However, different browsers use different processes to determine the HTML of an element. Thus, it is difficult to consistently track information when different visitors use different browsers. Accordingly, effective comparison and identification of elements (see Section F, above) requires that the HTML is normalized to a common standard. The present invention may use several techniques to normalize the HTML including, but not limited to, ignoring irrelevant tags, normalizing quotes, fixing invalid Extensible HyperText Markup Language (XHTML), and rearranging the order of attributes. The resulting combination of these processes produces normalized HTML regardless of the specific browser being used by a visitor. As a result, the present invention can use information from any browser.

H. Page Archival

According to at least some embodiments, the present invention maintains an archive of each page a customer has ever tracked, thereby allowing a customer to view old reports and analyze how each page has evolved over time. The archive of the present invention remains intact even if the customer's web site is altered or removed.

In at least some embodiments, the present invention uses a custom-developed shot server, which is a server that is used to take images of a webpage, to maintain a safe archive of every page. The shot server may create a full-length image of a web page at various screen widths and with various browsers, thereby enabling the image to be viewed on screens of various widths or on systems using various browsers.

In some embodiments, the shot server uses virtual displays that are stored to hard disk. A virtual display is a method that allows the server to package the data in a way that can be accessed by a customer's browser upon request. This allows the display to be any dimension and allows a single server to have multiple displays. Each time a new shot is requested, the shot server downloads the HTML source of the page and saves it to the database. The shot is then added to the queue, which triages shot requests according to the order in which they are received. A separate thread, i.e., a server process, is then started to process the next item in the queue such that all shots are acquired over time. In addition, on regular intervals the next item in the queue is processed in a new thread. When a shot is processed, a browser is opened inside an available virtual display. The browser makes a request to display the page. This request executes a server process that returns the original page source with an additional line of Javascript. This additional line of Javascript transfers the page's Element Identification Script and an additional Screenshot Script to the tracking servers. The Element Identification Script identifies all the trackable elements and stores their position, dimensions, and identifications. The Screenshot Script resizes the browser window to the desired width and full height of the page and then sends the element position data and window dimensions to the shot server. Next, server software takes a screenshot of the virtual display with the coordinates provided by the Screenshot Script and saves the image file to the hard disk. The shot is then updated and moved into a sending queue. When the sending queue is processed the complete element data and image file are transferred over HTTP to the original, requesting tracking server.

1. Site Overlay

In at least some embodiments, the present invention provides information in the form of a site overlay: statistical information generated by the tracking script is overlaid onto each customer's webpage. In at least some embodiments, the invention produces this overlay by (1) downloading a copy of the customer's current webpage at the moment the customer requests the summary report; (2) identifying elements on the customer's web page (as described above); and (3) replacing common ads with a graphic that identifies the sponsoring ad network. The invention then uses an iframe to display the customer's web page. As discussed previously, an iframe is, effectively, a self-contained webpage within a webpage. Using an iframe prevents the customer's webpage from interfering with the tracking script report by separately and independently containing the customer's webpage in a designated area within the reporting interface.

In at least some embodiments of the present invention, the site overlay includes an element overlay. The element overlay separates the different elements (invisibly) in order to display statistics associated with each element. In some embodiments, the element overlay displays color-coded buttons next to each tracked element. In some embodiments, the color of these buttons change based on the relative number of times the element has been clicked (e.g., blue may represent the fewest number of clicks and red may represent the highest, with varying tones in between). If a customer clicks one of these buttons, the associated element is outlined and a mini-overlay is displayed next to the element showing statistics of interest for the element.

The site overlay may also include an element list (see below) and a heatmap (see below).

J. Element List

In some embodiments, the site overlay includes an element list. An element list is a table that displays a text description of each element and statistics of interest for that element (e.g., number of clicks).

In at least some embodiments, the invention derives the text description for each element by considering a variety of element characteristics. In some embodiments, customers are also able to identify the element using that “glance” feature: when the customer moves his/her mouse over an element in the element list a glance of the HTML for the element automatically appears. The glance feature also parses and incorporates style information from the customer's web page, thereby yielding a glance that is a close approximation of the element's actual appearance. For example the text description of an element that is an image of a car might read “car image”. The “glance” would show the actual car image.

K. Heatmap

In at least some embodiments of the present invention, the heatmap is a separate feature that visually represents visitor activity on a customer's webpage. In some embodiments, the heatmap may depict activity including, but not limited to, the intensity and location of all click activity on a webpage or the manner in which users move their mouse around on a web page before exiting the page.

The heatmap may be generated using several image processing libraries and custom code. In some embodiments, the heatmap plots each data point as a white circle of varied transparencies onto a black “canvas.” Next, a Gaussian blending algorithm may be used to create a smooth intensity distribution over the different areas, ultimately resulting in a grayscale image. The intensity of each pixel is then translated into a corresponding color (e.g., from black to blue to green to red to yellow and to white). The colors work to provide a better visual representation of the data. The heatmap image may then be scaled up to meet the dimensions of the page and overlaid with semi-transparency on the customer's web page. The semi-transparency allows customers to see their actual page while viewing the heatmap.

L. Timeline

In at least some embodiments, the present invention allows customers to flip through their various web pages using a timeline tool. As customers navigate throughout the timeline, the tool presents a thumbnail image of the snapshot available at the selected time. A thumbnail version of the heatmap may be superimposed on top of each snapshot. Thus, customers are able to visualize trends in activity on their web pages over a period of time. In some embodiments, this timeline could capture real-time visitor activity.

M. Web API

In at least some embodiments, the present invention offers an Application Programming Interface (API) that uses web services technology. The API allows registered users with a valid key to:

search and retrieve reporting data;

generate a heatmap, as described above, based on given criteria; and/or

create a new snapshot.

N. RSS Feed

In at least some embodiments, the present invention also permits customers to subscribe to an RSS feed, i.e., an Extensible Markup Language file or XML, which is a generic specification for data formats that is used as a notification method, for a given page session. The RSS feed may be automatically updated at regular time intervals with a summary that includes the number of visitors, the number of clicks, and a heatmap (as described above) at the time of the update. Thus, customers are able to automatically keep track of their information on a regular basis with minimal effort.

What is claimed is:

1. A method for tracking browsing activity comprising:
loading a tracking script on a visitor's web browser when a customer's web page is loaded, wherein the tracking script is unique to the customer;
passively monitoring browser events with the tracking script;
when one of the browser events occurs, registering the monitored browsing event to collect information about a trackable element; and
sending the collected information to a tracking server without interrupting the visitor's activities on the customer's web page.

2. The method of claim 1, wherein the tracking script is determined by the elements on the customer's web page.

3. The method of claim 1, further comprising, when one of the monitored browser events occurs, creating a request object including a command that begins packaging the information to be sent to the tracking server.

4. The method of claim 3, further comprising using the request object to break down the information obtained from the visitor's web browser into smaller pieces that fit within a limit of the web browser.

5. The method of claim 4, further comprising tagging each piece with a unique index and a sequence ID to facilitate processing of the information at the tracking server.

6. The method of claim 5, further comprising using the request object to dynamically create an image object, wherein the image object allows the tracking script to send requests in the background without tracking information inside the web browser.

7. The method of claim 1, wherein the browser events comprise one or more of mouse movements, mouse clicks, and page exits.

8. The method of claim 1, wherein registering the monitored browsing event to collect information comprises collecting a position of a mouse on the customer's web page using the tracking script.

9. The method of claim 1, further comprising collecting with the tracking script an amount of time transpired between loading of the customer's web page and a user click.

10. The method of claim 1, wherein if the tracking server fails, the customer's web pages continue to be accessible and operate normally.

11. The method of claim 1, wherein the only consequence of a tracking server failure is an inability to track browsing activity.

12. The method of claim 1, further comprising obfuscating the tracking script by, each time the visitor requests to view the tracking script, checking HTTP header information of the visitor to determine whether the visitor matches a URL of the page version.

13. The method of claim 12, wherein, if the visitor matches the URL of the page version, rendering source code of the tracking script and, if the visitor does not match the URL of the page version, rendering a copyright script.

14. The method of claim 1, further comprising placing with the tracking script an invisible grid over each iframe on the customer's web page.

15. The method of claim 14, wherein, when the visitor moves a mouse over the grid, hiding a square in the grid and creating a new and more-refined grid inside of the square's area.

16. The method of claim 1, further comprising determining a similarity score between two pieces of HTML, wherein the similarity score determines the similarity between the two.

17. The method of claim 1, further comprising normalizing HTML by ignoring irrelevant tags, normalizing quotes, fixing invalid Extensible HyperText Markup Language (XHTML), and rearranging an order of attributes.

18. A tracking script comprising:
a client-based script code that, when in use, is executed in a visitor's web browser when a customer's web page is loaded on the visitors' computer, wherein the script code is unique to the customer and contains instructions for:
passively monitoring browser events;
when one of the monitored browser events occurs, registering the browser event to collect information about a trackable element; and
sending the collected information to a tracking server without interrupting the visitor's activities on the customer's web page.

19. The tracking script of claim 18, wherein the script code further comprises instructions for:
creating a request object including a command that begins packaging the information to be sent to the tracking server, wherein the request object breaks down the information obtained from the visitor's web browser into smaller pieces that fit within a limit of the web browser, wherein the request object dynamically creates an image object, wherein the image object allows the tracking script to send requests in the background without tracking information inside the web browser.

20. A tracking script comprising:
means for loading a tracking script on a visitor's web browser when a customer's web page is loaded, wherein the tracking script is unique to the customer;
means for passively monitoring browser events;
means for, when one of the monitored browser events occurs, registering the browser event to collect information about a trackable element; and
means for sending the collected information to a tracking server without interrupting the visitor's activities on the customer's web page.
